(19) United States
(12) Patent Application Publication
(10) Pub. No.: US 2015/0014241 A1
(43) Pub. Date: Jan. 15, 2015

(54) FILTER ELEMENT OF A FILTER, MULTILAYER FILTER MEDIUM OF A FILTER AND FILTER

(71) Applicant: MANN+HUMMEL GMBH, Ludwigsburg (DE)

(72) Inventor: Heiko Wyhler, Stuttgart (DE)

(21) Appl. No.: 14/331,845

(22) Filed: Jul. 15, 2014

(30) Foreign Application Priority Data
Jul. 15, 2013 (DE) 10 2013 011 711.9

(51) Int. Cl. B01D 39/08; B01D 29/31

(52) U.S. Cl. CPC B01D 39/083; B01D 29/31
USPC 210/497.01; 210/506; 210/507

(57) ABSTRACT

A filter element of a filter for filtering fluid has a multilayer filter medium through which the fluid flows in a flow direction from an inflow side to an outflow side of the filter medium for filtration. The filter medium has several layers including at least one filtration layer and at least one support layer. The at least one support layer supports the filter medium against pressures having pressure gradients transverse or oblique to the flow direction of the fluid through the filter medium.

### CROSS-REFERENCE TO RELATED APPLICATION

This application claims the benefit of German patent application No. 10 2013 011 711.9 filed Jul. 15, 2013, the entire contents of the aforesaid German patent application being incorporated herein by reference.

### BACKGROUND OF THE INVENTION

The invention relates to a filter element of a filter for filtering fluid, in particular liquid fluid, in particular urea solution, in particular of an internal combustion engine, in particular of a motor vehicle, the filter element comprising a multilayer filter medium through which the fluid can flow for the purpose of filtering, and which has at least one filtration layer and at least one support layer.

The invention further relates to a multilayer filter medium of a filter for filtering fluid, in particular liquid fluid, in particular urea solution, in particular of an internal combustion engine, in particular of a motor vehicle, through which filter medium a fluid can flow for the purpose of filtering, and which has at least one filtration layer and at least one support layer.

Moreover, the invention relates to a filter for filtering fluid, in particular liquid fluid, in particular urea solution, in particular of an internal combustion engine, in particular of a motor vehicle, the filter comprising a multilayer filter medium through which a fluid can flow for the purpose of filtering, and which has at least one filtration layer and at least one support layer.

An urea filter material for a urea filter having three layers, namely a support layer, a cover layer, and filter layer therebetween, is known from DE 10 2011 003 585 A1. All layers are made of polypropylene, in particular of a polypropylene nonwoven. The support layer consists of a more stable polypropylene nonwoven that mainly ensures the support function for the filter layer, whereas the filter layer consists of a more voluminous polypropylene nonwoven so as to guarantee the desired filtering effect by means of a suitable pore size. The cover layer in turn is intended to ensure that the soft filter layer is not destroyed by mechanical friction. It therefore consists of a comparatively thin and smooth polypropylene fleece.

It is an object of the invention to configure a filter element, a multilayer filter medium and a filter of the aforementioned kind for/with which service life and/or robustness is improved.

### SUMMARY OF THE INVENTION

This object is achieved according to the invention for the filter element in that the at least one support layer is adapted to support the filter medium, i.e., configured and/or arranged in such a manner that it is able to support the filter medium, against pressures that have pressure gradients transverse or oblique to the flow direction of the fluid through the filter medium.

Advantageously, the pressures can be oriented substantially in the flow direction of the fluid through the filter medium.

The support layer advantageously also serves at least for increasing the inherent rigidity of the filter medium so as to improve the processability thereof. For example, bending of the filter medium when pressing it into a molten end plate is prevented.

The filter medium is composed of a plurality of layers. The layers can each have different properties with respect to their filtering properties, in particular pore size and/or pore density, and/or with respect to their mechanical properties, in particular compressive stability and/or dimensional stability and/or inherent rigidity. Thus, the layers can be optimized with regard to their function. In the case of filter layers that have adequately small pore sizes, in addition, it is therefore not necessary that they are also mechanically stable. At least two layers of the filter medium can advantageously be connected to one another. They can in particular be bonded face-to-face to one another.

According to the invention, the at least one support layer is designed such that it is also able to compensate spatially limited, almost punctiform pressure loads. It is thus able to protect the other layers of the filter medium against singular pressure loads. Such pressure loads have a pressure gradient transverse or oblique to a flow direction of the fluid through the filter medium. Thus, the at least one support layer is able to better protect the entire filter medium against mechanical load. The at least one support layer thus is also able to support the filter medium against pressure differences between the inflow side and the outflow side, which pressure differences are uniform along the surface area of the layers of the filter medium, in particular transverse or oblique to the flow direction.

The at least one support layer can advantageously be resistant to frost and/or ice pressure. Frost and ice pressure can exert pressure loads onto the filter medium which show a pressure gradient along the surface area of the filter medium. Thus, the at least one support layer is able to reliably and permanently stabilize the filter medium even if the fluid, in particular the urea solution, is cooled down below its freezing point.

Moreover, the at least one support layer can provide protection against ice blast. In particular when using the filter element at low temperatures, in particular below the freezing point of the fluid, it may occur that ice particles are formed in the fluid. The ice particles can exert almost punctiform load onto the filter medium. Pressure caused by ice particles can result in correspondingly great pressure gradients.

The inherent rigidity of the filter medium achieved through the at least one support layer can advantageously at least be improved. In this manner, it is simpler to bring the filter medium into an adequate shape and to maintain it. In particular, the filter medium can be folded, in particular pleated, in a simpler manner. After folding, the filter medium can better maintain its shape by means of the at least one support layer. Due to the improved inherent rigidity, it is easier to connect the filter medium to at least one suitable frame element, in particular an end body, specifically an end plate, of the filter element. In particular, by means of the at least one support layer, the filter medium can be welded, adhesively bonded or connected in a different way, in particular mechanically, to the at least one frame element. It is also conceivable to injection mold the frame element onto the filter medium.

The at least one support layer can additionally have flow-influencing, in particular flow-guiding properties, at least in certain sections. Depending on the arrangement of the at least one support layer in the filter medium, inflowing of the fluid into the filter medium and/or outflowing of the fluid from the filter medium can be improved in this manner. Thus, draining the fluid can also be improved by means of the at least one support layer. Furthermore, a pressure difference between the inflow side and the outflow side of the filter medium can be reduced.

In order to achieve the specific support function against pressures having corresponding pressure gradients, the at least one support layer can have specific properties. The specific properties can in particular be characterized by a specific structure and/or a specific manufacturing method and/or a specific material composition and/or specific material properties.

In an advantageous embodiment, at least one support layer can comprise a fabric. In particular, the at least one support layer can be made from a fabric. Through the specific properties of the fabric, the specific support function of the at least one support layer against pressures having corresponding pressure gradients can be improved. In particular, a fabric can absorb, transmit and/or compensate compressive and tensile loads transverse or oblique to the flow direction of the fluid through the filter medium. A yarn diameter of the at least one support layer containing/made from a fabric (fabric support layer) can advantageously range between approximately 100 μm and approximately 500 μm, preferably between approximately 300 μm and approximately 450 μm. A thickness of the at least one fabric support layer can advantageously range between approximately 300 μm and approximately 900 μm, preferably between approximately 500 μm and approximately 800 μm. A mass per unit area of the at least one fabric support layer can advantageously range between approximately 100 g/m² and approximately 300 g/m², preferably between approximately 200 g/m² and approximately 280 g/m².

The thickness of a layer of the filter medium in the meaning of the invention is its extent approximately in the direction of the mean flow direction of the fluid through the filter medium.

In another advantageous embodiment, alternatively or additionally, at least one support layer can have a mesh. Advantageously, the at least one support layer can be a mesh. By the specific properties of the mesh, the specific support function of the at least one support layer against pressures having corresponding pressure gradients can be improved. In particular, a mesh can absorb, transmit and compensate tensile and compressive loads transverse or oblique to the flow direction of the fluid through the filter medium. The at least one support layer containing/made from the mesh (mesh support layer) can advantageously have a thickness between approximately 500 μm and approximately 1300 μm, preferably between approximately 700 μm and approximately 1100 μm. The mass per unit area of the at least one mesh support layer can approximately range between 50 g/m² and approximately 250 g/m², preferably between 150 g/m² and approximately 230 g/m².

In another advantageous embodiment, alternatively or additionally, at least one support layer can comprise a spunbonded fabric. In particular, the at least one support layer can be made from a spunbonded fabric. As is well known, spunbonded fabric can also be designated as spunbond. The specific support function of the at least one support layer against pressure having corresponding pressure gradients can be improved by the specific properties of the spunbonded fabric. In particular, the spunbonded fabric can absorb, transmit and compensate tensile and compressive loads transverse or oblique to the flow direction of the fluid through the filter medium. The thickness of the at least one support layer containing/made from a spunbonded fabric (spunbond support layer) can advantageously range between 300 μm and 1000 μm. The mass per unit area of the at least one spunbond support layer can advantageously range between 70 g/m² and approximately 250 g/m², preferably between approximately 100 g/m² and approximately 170 g/m². The at least one spunbond support layer can advantageously exhibit air permeability of approximately 250 l/m²s up to approximately 3000 l/m²s, preferably between approximately 500 l/m²s and approximately 1500 l/m²s. Fiber diameters of the fibers of the at least one spunbond support layer can advantageously range between approximately 1 μm and approximately 50 μm.

Alternatively or additionally, the specific support function against pressures having corresponding pressure gradients can be achieved by a specific arrangement of the at least one support layer in the multilayer filter medium relative to the other layers and/or relative to the inflow side and/or outflow side of the filter medium.

The specific properties of the at least one support layer can advantageously also be predetermined depending on the specific arrangement of the at least one support layer in the filter medium or vice versa. The specific properties and the specific arrangement of the at least one support layer can be adequately combined so as to achieve optimal filtration properties and/or an optimal service life of the filter element.

In another advantageous embodiment, at least one filtration layer can be arranged downstream of at least one support layer with regard to the flow of the fluid through the filter medium. In this manner, the at least one support layer can protect the at least one filtration layer against large particles, in particular against ice blast. The at least one support layer can in addition also act as a pre-filtration layer for the actual filtration layer. By filtering out large particles with the at least one support layer, loading of the at least one filtration layer can be delayed. Thus, the service life of the filter medium and therefore of the filter element can be prolonged.

In another advantageous embodiment, at least one support layer can be arranged on an inflow side of the filter medium. In this manner, the at least one support layer can protect all other layers of the filter medium against larger particles, in particular against ice blast. Furthermore, loading of the downstream finer filtration layers can be delayed. The at least one support layer can advantageously exhibit flow-influencing properties through which inflowing of the fluid into the filter medium can be improved.

In another advantageous embodiment, at least one filtration layer can be arranged upstream of the at least one support layer with regard to the flow of the fluid through the filter medium. In this manner, the at least one filtration layer is better supported on the at least one support layer. In particular, pressure of the fluid acting on the at least one support layer, in particular with a pressure gradient oblique or transverse to the flow direction, can be distributed more uniformly over the at least one support layer.

In another advantageous embodiment, at least one support layer can be arranged on an outflow side of the filter medium. In this manner, the other layers of the filter medium, which are arranged upstream of the at least one support layer in the flow direction of the fluid, can be better supported on the at least one support layer. Thus, the stability of the filter element during operation can be further improved. If the at least one support layer additionally has flow-influencing properties, it can improve the outflowing of the fluid from the filter medium. Draining is in particular improved in that the filtration layer is kept at a distance by the support layers, and the flow therefore remains ensured.

Alternatively or additionally, at least one support layer can advantageously be located as an intermediate layer between two other layers, even different layers, of the filter medium. In this manner, layers located on the inflow side can be supported on the at least one support layer. Furthermore, the at least one support layer can serve as a pre-filter for the layers situated in flow direction on the outflow side.

Preferably, at least one layer of the filter medium, specifically that layer that forms the inflow side of the filter medium, is hydrophilic; in particular, all layers of the filter medium are hydrophilic. Thus, in the case of the filtration of a urea solution, this results in good wettability of the filter medium with the fluid.

The at least one filtration layer can advantageously comprise pore openings which are smaller than the smallest particles that may occur in the fluid, in particular in the urea solution. In this manner, the particles can be reliably filtered out.

The filtration layer preferably has a gradient structure, i.e., the packaging density increases in the flow direction.

In another advantageous embodiment, at least one filtration layer can comprise a nonwoven. For example, a nonwoven from staple fibers can be used. Advantageously, the at least one filtration layer can be a nonwoven. The at least one filtration layer containing/made from nonwoven (nonwoven filtration layer) can have a thickness between approximately 400 μm and approximately 1500 μm. A mass per unit area of the at least one nonwoven filtration layer can advantageously range between approximately 150 g/m² and approximately 500 g/m². The at least one nonwoven filtration layer can advantageously exhibit air permeability between approximately 80 l/m²s and approximately 250 l/m²s. A fiber diameter of the at least one nonwoven filtration layer can advantageously range between approximately 4 μm and approximately 200 μm.

In another advantageous embodiment, alternatively or additionally, at least one filtration layer can be melt-blown, at least partially. Melt-blown media in the meaning of the invention are designated as “meltblown”. The at least one meltblown filtration layer can advantageously have a thickness between approximately 200 μm and approximately 1000 μm. The at least one meltblown filtration layer can advantageously have a mass per unit area between approximately 50 g/m² and approximately 150 g/m². The at least one meltblown filtration layer can advantageously exhibit air permeability between approximately 80 l/m²s and approximately 170 l/m²s. Advantageously, a fiber diameter of the at least one meltblown filtration layer can range between approximately 0.1 μm and approximately 15 μm.

The terms meltblown and spunbond are defined, e.g., in “Vliesstoffe: Rohstoffe, Herstellung, Anwendung, Eigenschaften, Prüfung, 2^{nd} edition, 2012, Weinheim”, ISBN: 978-3-527-31519-2.

In another advantageous embodiment, the filter medium can comprise at least one barrier layer. With the at least one barrier layer it can be prevented that fibers, in particular nonwoven fibers of the layers arranged upstream in the flow direction are flushed out of the filter medium. In this manner, component cleanliness of the filter element can be increased. The at least one barrier layer can advantageously be arranged downstream of the at least one filtration layer in the flow direction of the fluid.

The at least one barrier layer can advantageously be located on the outflow side of the filter medium. In this manner, the at least one barrier layer can collect the particles or fibers which flow through all layers upstream of the filter medium in the flow direction or which are flushed out from the filter medium. Through this, the cleanliness of the outflowing fluid can be further improved.

In another advantageous embodiment, the at least one barrier layer can comprise a spunbond. Advantageously, the at least one barrier layer can be a spunbond. The at least one barrier layer containing/made from spunbond (spunbond barrier layer) can advantageously have a thickness between approximately 100 μm and approximately 300 μm. Advantageously, the at least one spunbond barrier can have a mass per unit area between approximately 15 g/m² and approximately 80 g/m². Air permeability of the at least one spunbond barrier layer can advantageously range between approximately 250 l/m²s and approximately 3000 l/m²s. The at least one spunbond barrier layer can advantageous have a fiber diameter between 1 μm and 50 μm.

In another advantageous embodiment, the filter medium can comprise at least one ultra-fine filter layer. The at least one ultra-fine filter layer can advantageously have a smaller pore size than the at least one filtration layer. The at least one ultra-fine filter layer can advantageously be arranged downstream of the at least one filtration layer in the flow direction of the fluid. In this manner, the smallest particles which may pass through the at least one filtration layer can be filtered out of the fluid by means of the at least one ultra-fine filter layer. The at least one filtration layer can be used to filter out in first instance the larger particles. Thus, they cannot reach the at least one ultra-fine filter layer. Loading the at least one ultra-fine filter layer can be delayed in this manner. Through multi-stage filtration, improvement of the separation efficiency can be achieved. Furthermore, the requirements for the individual layers, in particular for the at least one filtration layer, can be reduced. Thus, a production process for the individual layers, in particular the at least one filtration layer, can be simplified. In addition, the service life of the filter element can be increased by multi-stage filtration.

The at least one ultra-fine filter layer can advantageously be arranged on the outflow side of the filter medium. In this manner, smaller particles, which may pass through the layers arranged upstream in the flow direction, can also be filtered out with the at least one ultra-fine layer.

Alternatively or additionally, at least one ultra-fine layer can advantageously be arranged upstream of at least one support layer in the flow direction of the fluid. In this manner, the at least one ultra-fine filter layer can be supported on the at least one support layer.

In another advantageous embodiment, the at least one ultra-fine filter layer can be molt-blown, at least partially. In particular, the at least one ultra-fine layer can be a meltblown ultra-fine filter layer. The at least one meltblown ultra-fine filter layer can advantageously have a thickness between approximately 100 μm and approximately 500 μm. It can advantageously have a mass per unit area between approximately 15 g/m² and approximately 100 g/m². Air permeability of the at least one meltblown ultra-fine filter layer can advantageously range between approximately 40 l/m²s and approximately 100 l/m²s. The at least one meltblown ultra-fine filter layer can advantageously have a fiber diameter between approximately 0.1 μm and approximately 15 μm.

In the field of internal combustion engines, in particular diesel engines, urea solutions are used in systems for exhaust gas treatment in order to reduce emissions, in particular nitrogen emissions. Here, the urea solution is cleaned using special urea filters. In this connection, particles possibly present in the urea solution are removed. When using the filter element in a urea filter, the at least one filtration layer serves for filtering the urea solution.

The urea solution can be a urea/water solution and/or a different kind of urea solution, in particular including containing (imino urea), guanidine salts or guanidine esters.

Extensive studies have shown that the service life of the filter media, the filter elements and the filters, in particular for urea solution, depend on the materials of which the filter media are made of.

Advantageously, the multilayer filter medium can be fully synthetic. Fully synthetic filter media have a higher level of resistance to urea solution and other especially aggressive fluids than, in particular, cellulose. By using fully synthetic filter media, components can also be implemented that do not require replacement for the life of the product.

Advantageously, all layers of the filter material can be made of a similar, preferably the same material. In this manner, connections between the layers, and/or of the layers to at least one frame element, in particular an end body of the filter element can be simplified.

In an advantageous embodiment, at least one of the layers of the filter medium can comprise polyamide and/or polypropylene. Advantageously, at least one of the layers of the filter medium can be made of polyamide (PA) and/or polypropylene (PP). In particular, at least one support layer and/or at least one filtration layer and/or at least one barrier layer and/or at least one ultra-fine layer can be made of polyamide and/or polypropylene or can contain polyamide and/or polypropylene. Preferably, all layers of the filter medium can be made of polyamide and/or polypropylene, or can contain polyamide and/or polypropylene. Polyamide and polypropylene show a level of resistance to urea solution or other fluids, in particular aggressive fluids, that is higher compared to cellulose or polybutylene terephthalate (PBT). Thus, service life and resistance of the filter element can be increased.

Instead of being made from polyamide and/or polypropylene, at least one layer of the filter medium can also be made from another polymer or copolymer that preferably is resistant with respect to urea solution or other fluids, in particular aggressive fluids.

In another advantageous embodiment, the filter element can be a hollow filter element. In the case of a hollow filter element, the multilayer filter medium can surround a hollow space of the filter element in a closed manner at least in one circumferential direction. Advantageously, a flow can pass through the hollow filter element radially from the inside to the outside with regard to an element axis. The inflow side of the filter medium is then located radially on the inside and the outflow side is located radially on the outside. Alternatively, the flow can also pass through the hollow filter element radially from the outside to the inside. The inflow side of the filter medium is then located radially on the outside and the outflow side is located radially on the inside.

Advantageously, the hollow filter element can be a round filter element, an oval round filter element, a conical round filter element, a conical-oval round filter element or a different kind of a round filter element. The hollow filter element can also have a square cross-section.

The circumferentially closed filter medium of the hollow filter element can be connected at least at one of its front faces to an end body, in particular to an end plate. Advantageously, an end body can be arranged on each of the two front faces.

Advantageously, at least one end body of the hollow filter element can be made from a material that is also contained in the filter medium, in particular from the material the filter medium is made from. In this manner, the filter medium and the at least one end body can be connected to one another in a simpler manner. In particular, the filter medium can be connected to the at least one end body by means of a welding method, in particular an infrared welding method, or by means of an injection molding method.

Instead by means of welding, the filter medium can also be connected in a different manner to the at least one end body. In particular, the filter medium can be adhesively bonded to the at least one end body or can be adhesively bonded therein. Advantageously, an adhesive used for this purpose can be resistant to the fluid, in particular the urea solution or the urea/water solution and/or another particularly aggressive fluid.

The at least one end body can advantageously be made from a polymer or copolymer. The at least one end body can additionally have a glass fiber content. In this manner, the stability of the at least one end body can be further improved. Additionally or alternatively, at least one different kind of filler, in particular talcum, can also be contained. The filler content can advantageously be less than 45%.

Advantageously, the filter medium can contain polyamide or can consist thereof and can be connected to at least one end body containing/made from polyamide, in particular polyamide 6 having a glass fiber content of approximately 30% (PA 6 GF30), by means of a welded joint.

Alternatively or additionally, the filter medium can contain polypropylene or can consist thereof and can be connected by means of a welded joint to at least one end body containing/made from polypropylene, in particular polypropylene having a glass fiber content of up 35%, in particular of approximately 35% (PP GF 35), and/or containing polypropylene having a talcum content of up to 20%, in particular of approximately 20% (PPT 20), and/or containing a different kind of copolymer (polypropylene/polyethylene).

The hollow filter element can also comprise at least one support body, in particular a central tube and/or struts and/or stiffening ribs. In this manner, the hollow filter element can be additionally stabilized. Also, different material pairings between the at least one end body and the filter medium can be implemented in this manner. Thus, it is also possible to connect materials to one another, the direct connection of which exhibits a lower stability than, in particular, a welded joint between polyamide and polyamide, polypropylene and polypropylene or polyamide and polypropylene. The at least one support body is adapted to stiffen the hollow fiber element, i.e., can advantageously be configured and/or arranged such that the hollow filter element is stiffened in the direction of its element axis, thus in the longitudinal direction.

For circumferential closing, the filter medium of the hollow filter element can be connected at its respective edges in particular by means of a bellows end seam. The bellows end seam can be implemented by means of a welding method, in particular an ultrasonic welding method, and/or by means of an adhesive bond. As an alternative, the edges of the filter medium can also be connected to one another in a positive-locking or nonpositive-locking manner, in particular by means of a bellows seam clamp.

Instead of being configured as a hollow filter element, the filter element can also be configured as a flat filter element. In the case of the flat filter element, the edges of the filter medium are not connected to one another.

The filter medium can advantageously be folded in a zigzag-shaped manner. With a folded filter medium, an active surface area for filtering can be increased compared with a required installation volume. The folding can be sharp-edged or can be bent with a gentle bending radius. In the latter case, the zigzag-shaped folding is formed wavy. Folding can advantageously be carried out through rotation, in particular by means of rotating rollers, or by means of knife pleating.

An initial separation efficiency of the filter element for particles that are larger or equal to 10 μm(c) can be greater than 80%. The initial separation efficiency for particles larger than or equal to 15 μm(c) can be greater than 92%. For particles that are larger than or equal to 20 μm(c), the initial separation efficiency can be greater than 97%. The initial separation efficiency for particles larger than or equal to 30 μm(c) can be 100%. The initial separation efficiency of the filter element can in particular be defined according to ISO 19438.

The technical object regarding the multilayer filter medium is also achieved in that the at least one support layer is adapted to support the filter medium, i.e., is configured and/or arranged in such a manner that it can support the filter medium, against pressures that have pressure gradients transverse or oblique to a flow direction of the fluid through the filter medium.

The advantages and features shown above in connection with the filter element and the advantageous embodiments thereof apply correspondingly and vice versa to the multilayer filter medium according to the invention and the advantageous embodiments thereof.

Moreover, the technical object regarding the filter is achieved in that the at least one support layer is adapted to support the filter medium, i.e., is configured and/or arranged in such a manner that it can support the filter medium, against pressures that have pressure gradients transverse or oblique to a flow direction of the fluid through the filter medium.

The advantages and features shown above in connection with the filter element according to the invention and the multilayer filter medium according to the invention and their respective advantageous embodiments apply correspondingly and vice versa to the filter according to the invention.

### BRIEF DESCRIPTION OF THE DRAWINGS

Further advantages, features and details of the invention arise from the following description in which exemplary embodiments of the invention are explained in greater detail with reference to the drawing. The person skilled in the art will expediently consider the features disclosed in combination in the drawing, in the description and in the claims also individually and combine them to other meaningful combinations.

FIG. 1 shows an isometric illustration of a filter element of a urea filter for urea solution of an internal combustion engine of a motor vehicle, comprising a two-layer filter medium according to a first exemplary embodiment.

FIG. 2 shows a cross-section of the filter element of FIG. 1.

FIG. 3 shows a detail of the two-layer filter medium from the FIGS. 1 and 2.

FIG. 4 shows a detail of a three-layer filter medium according to a second exemplary embodiment, which can be used for the filter element from the FIGS. 1 and 2.

FIG. 5 shows a detail of a three-layer filter medium according to a third exemplary embodiment, which can be used for the filter element from the FIGS. 1 and 2.

FIG. 6 shows a detail of a three-layer filter medium according to a fourth exemplary embodiment that can be used for the filter element from the FIGS. 1 and 2.

FIG. 7 shows a detail of a three-layer filter medium according to a fifth exemplary embodiment, which can be used for the filter element from the FIGS. 1 and 2.

FIG. 8 shows a detail of a three-layer filter medium according to a sixth exemplary embodiment, which can be used for a filter element from the FIGS. 1 and 2.

In the Figs., the same components are referenced with the same reference numerals.

### DESCRIPTION OF PREFERRED EMBODIMENTS

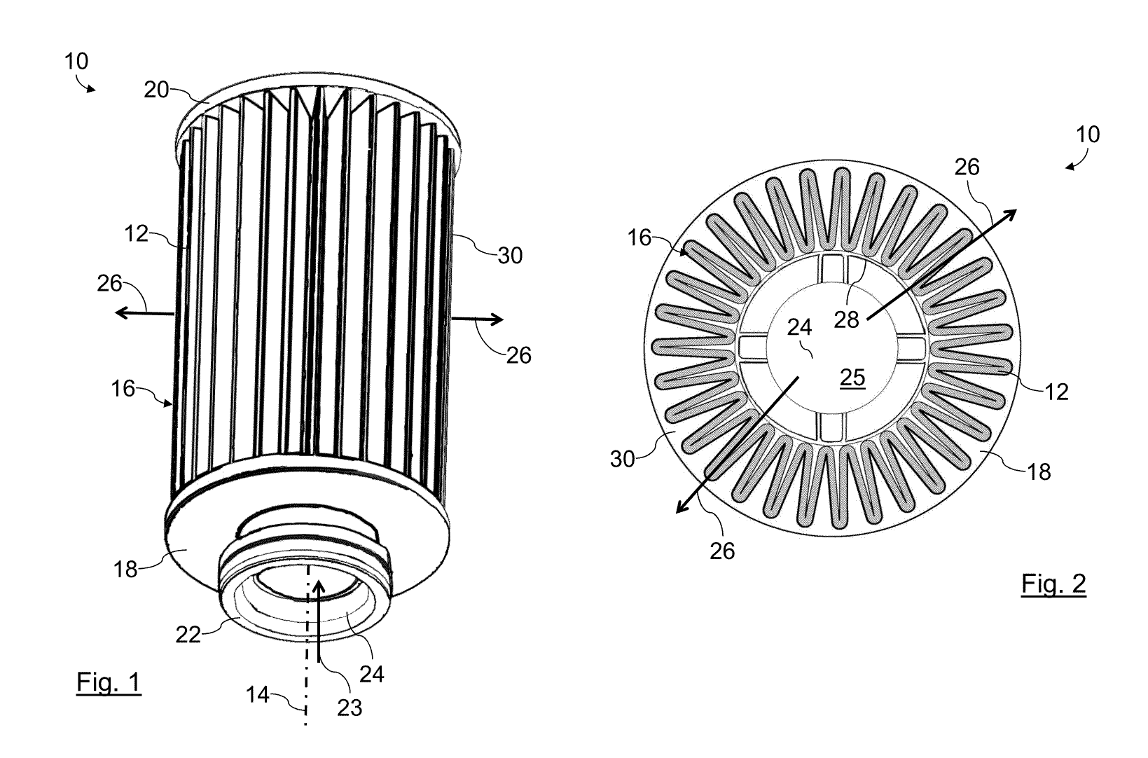

FIG. 1 shows a filter element 10 of an otherwise non-illustrated filter for urea solution of an internal combustion engine of a motor vehicle. FIG. 2 shows a cross-section of the filter element 10.

The filter element 10 is arranged in an otherwise non-illustrated filter housing of the filter. The filter housing has at least one inlet for the urea solution to be filtered and one outlet for the filtered urea solution. The filter is arranged in or on a tank for the urea solution.

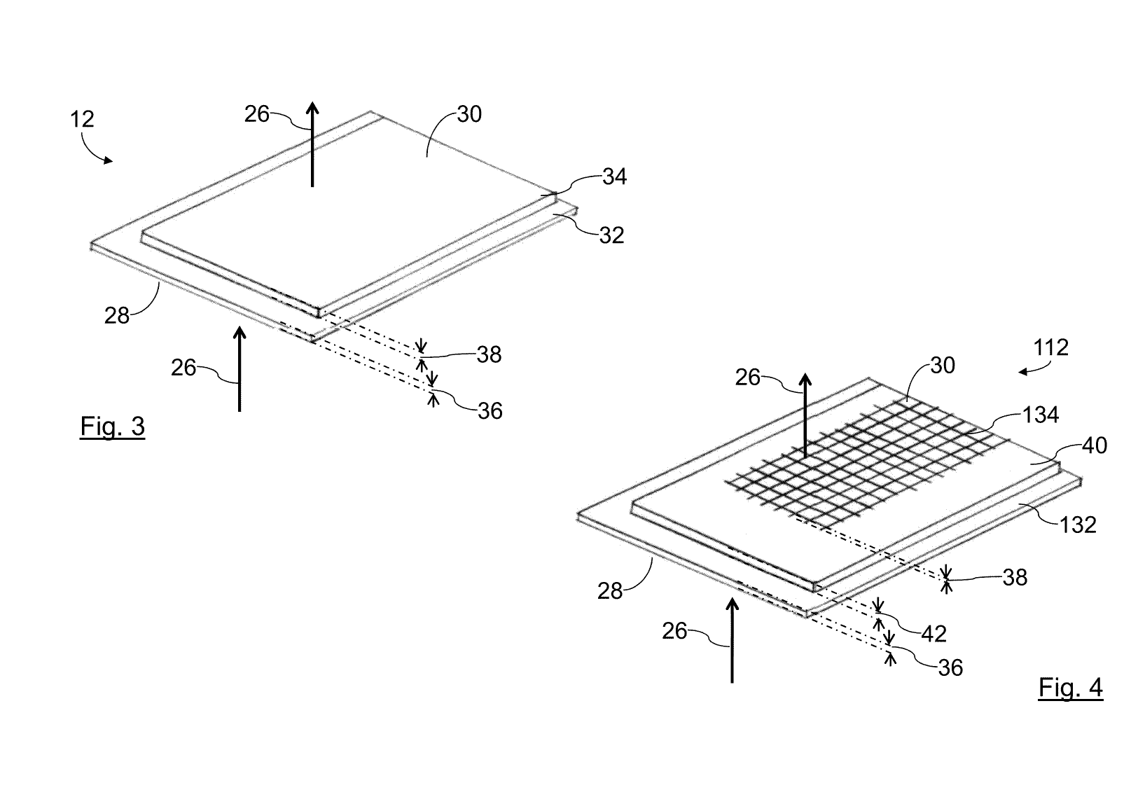

The filter element 10 is configured as a so-called round filter element. The filter element 10 comprises a multilayer filter medium 12 according to a first exemplary embodiment. The filter medium 12 forms a filter bellows 16. A detail of the filter medium 12 is shown in FIG. 3. The filter medium 12 is folded in a zigzag-shaped manner. Folding the filter medium 12 is carried out through rotation by means of rotating rollers. As shown in FIG. 2, the filter medium 12 is gently bent along the folding edges. The filter medium 12 is circumferentially closed with respect to an element axis 14. For circumferentially closing the filter bellows 16, corresponding edges of the filter medium 12 are tightly connected to one another by means of an ultrasonic welding method. The filter element 10, in particular the filter bellows 16, has a round cross-section.

At its front sides, the filter bellows 16 is in each case tightly connected to a connection end plate 18, shown at the bottom in FIG. 1, and to a closure end plate 20, shown at the top. The connection end plate 18 has a connection port 22 with a passage opening 24 for the urea solution. In the shown exemplary embodiment, the passage opening 24 serves as an inlet for the urea solution.

As indicated by an arrow 23, the urea solution passes through the passage opening 24 and reaches an element interior 25 of the filter bellows 16. From the element interior 25, the urea solution flows through the filter medium 12 radially from the inside to the outside, as indicated by arrows 26, and is filtered there. The filtered urea solution reaches an outlet chamber between the radially outer circumferential side of the filter bellows 16 and a radially inner circumferential side of a housing wall of the filter housing.

An inflow side 28 of the filter medium 12 faces towards a radially inner circumferential side of the filter bellows 16; the inner circumferential side faces towards the element interior 25. The inflow side 28 of the filter medium can also be designated as “raw side” or “dirt side”. An outflow side 30 of the filter medium 12 faces towards a radially outer circumferential side of the filter bellows 16; the outer circumferential side faces away from the element interior 25.

The front sides of the filter bellows 16 are in each case tightly connected to the end plates 20 and 22. The tight connections are implemented by means of an infrared welding method. The end plates 20 and 22 are made from a similar material, preferably from the same material as the filter medium 12. They are preferably made from polyamide (PA), polypropylene (PP) or a copolymer, for example, polypropylene/polyethylene (PP/PE).

For increasing the strength, the end plates 20 and 22 can additionally have a glass fiber content and/or another filler, for example talcum. The glass fiber content can amount to up to 45%. If the filter medium 12 contains polyamide, the end plates 20 and 22 can be made from, for example, PA 6 GF30 with a glass fiber content of 30%. If the filter medium 12 contains polypropylene, the end plates 20 and 22 can be made from, for example, PP GF35 with glass fiber content of 35%, PPT 20 or from a copolymer.

The filter element 10 has an overall initial separation efficiency of more than 80% for particles that are larger than or equal to 10 μm(c). For particles that are larger than or equal to 15 μm(c), the initial separation efficiency is greater than 92%. For particles that are larger than or equal to 20 μm(c), the initial separation efficiency is greater than 97%. For particles that are larger than or equal to 30 μm(c), the initial separation efficiency is 100%. The definition of the separation efficiency preferably is done according to ISO 19438.

The filter medium 12 has two layers. It has a filtration layer 32 located upstream with regard to the flow 26. The filtration layer 32 is manufactured using a meltblown method. It is therefore designated hereinafter as meltblown filtration layer 32. The meltblown filtration layer 32 serves for filtering out the particles that are possibly contained in the urea solution. It forms the inflow side 28.

A thickness of the meltblown filtration layer 32, indicated in FIG. 3 by a double arrow 36, ranges between approximately 200 μm and approximately 1000 μm. The mass per unit area of the meltblown filtration layer 32 ranges between 50 g/m² and 150 g/m². The meltblown filtration layer 32 exhibits air permeability between approximately 80 l/m²s and approximately 170 l/m²s. The meltblown filtration layer 32 has a fiber diameter between 0.1 μm and 15 μm. The meltblown filtration layer 32 is made from polyamide or polypropylene, or from a mixture of polyamide and polypropylene.

In the direction of the flow 26 downstream of the filtration layer 32, the filter medium 12 has a support layer 34. In this exemplary embodiment, the support layer 34 is made from a spunbond, which is illustrated in greater detail below. It is therefore designated hereinafter as spunbond support layer 34. The spunbond support layer 34 is bonded face-to-face to the filtration layer.

The spunbond support layer 34 forms the outflow side 30 of the filter medium 12. During the operation of the filter element 10, the spunbond support layer 34 provides a support function for the filtration layer 32. The filtration layer 32 can be supported on the spunbond support layer 34. The spunbond support layer 34 also supports the filter medium 12 against pressures having pressure gradients transverse or oblique to the direction of the flow 26 of the urea solution through the filter medium 12. The pressures are usually directed in the direction of the flow 26. Pressures that have such pressure gradients are, for example, areally limited pressures. They can be caused by ice blast, for example. Ice blast can occur, for example, at temperatures below the freezing point of the urea solution. Furthermore, the spunbond support layer 34 contributes to the overall stability of the filter medium 12 and the filter element 10. Thus, for example, the spunbond support layer 34 compensates pressure increases caused by deteriorated flowability of the urea solution. The spunbond support layer 34 also increases the stiffness of the filter medium 12. It improves the strength of the filter medium 12. The spunbond support layer 34 helps maintaining the folding of the filter medium 12. In addition, the spunbond support layer 34 increases the inherent rigidity of the filter medium 12. Thus, the connecting process with the end plates 20 and 22 can be simplified.

A thickness of the spunbond support layer 34 is indicated in FIG. 3 by a double arrow 38. The thickness 38 of the spunbond support layer 34 ranges between 300 μm and 1000 μm. The mass per unit area of the spunbond support layer 34 ranges between 100 g/m² and 170 g/m². The spunbond support layer 34 exhibits air permeability of between 500 l/m²s and 1500 l/m²s. The spunbond support layer 34 has fiber diameters between 1 μm and 50 μm. The spunbond support layer 34 is made from the same material as the meltblown filtration layer 32.

FIG. 4 shows a filter medium 112 according to a second exemplary embodiment, which can be used for the filter element 10. In contrast to the first exemplary embodiment from FIG. 3, a support layer 134 in the second exemplary embodiment is implemented as a mesh. The support layer 134 is designated hereinafter as mesh support layer 134. The mesh support layer 134 has a thickness 38 between 700 μm and approximately 1100 μm. The mass per unit area of the mesh support layer 134 ranges between approximately 150 g/m² and approximately 230 g/m². The mesh support layer 134 can be made from polyamide, polypropylene or a copolymer. Apart from that, the mesh support layer 134 fulfills the same functions as the spunbond support layer 34 in the third exemplary embodiment of FIG. 3.

Furthermore, in contrast to the first exemplary embodiment from FIG. 3, a filtration layer 132 from a nonwoven is provided instead of the meltblown filtration layer 32. The filtration layer 132 from nonwoven is designated hereinafter as nonwoven filtration layer 132. The thickness 36 of the nonwoven filtration layer 132 ranges between 400 μm and 1500 μm. The mass per unit area of the nonwoven filtration layer 132 ranges between 150 g/m² and 500 g/m². The nonwoven filtration layer 132 exhibits air permeability of between 80 l/m²s and 250 l/m²s. A fiber diameter of the nonwoven filtration layer 132 ranges between 4 μm and approximately 200 μm. The nonwoven filtration layer 132 is made from the same material as the mesh support layer 134 of the filter medium 112. Apart from that, the nonwoven filtration layer 132 fulfills the same functions as the meltblown filtration layer 32 in the first exemplary embodiment of FIG. 3.

In addition, a barrier layer 40 is provided between the nonwoven filtration layer 132 and the mesh support layer 134. The barrier layer 40 is arranged downstream of the nonwoven filtration layer 132. The barrier layer 40 is used for filtering out possible washouts of nonwoven fibers from the nonwoven filtration layer 132.

The barrier layer 40 is made from a spunbond. A thickness of the barrier layer 40 is indicated in FIG. 4 with a double arrow 42. The thickness 42 of the barrier layer 40 ranges between 100 μm and 300 μm. The barrier layer 40 has a mass per unit area between 15 g/m² and 80 g/m². Air permeability of the barrier layer 40 ranges between 250 l/m²s and 3000 l/m²s. A fiber diameter of the barrier layer 40 ranges between 1 μm and 50 μm. The barrier layer 40 is made from the same material as the mesh support layer 134 and the nonwoven filtration layer 132 of the filter medium 112.

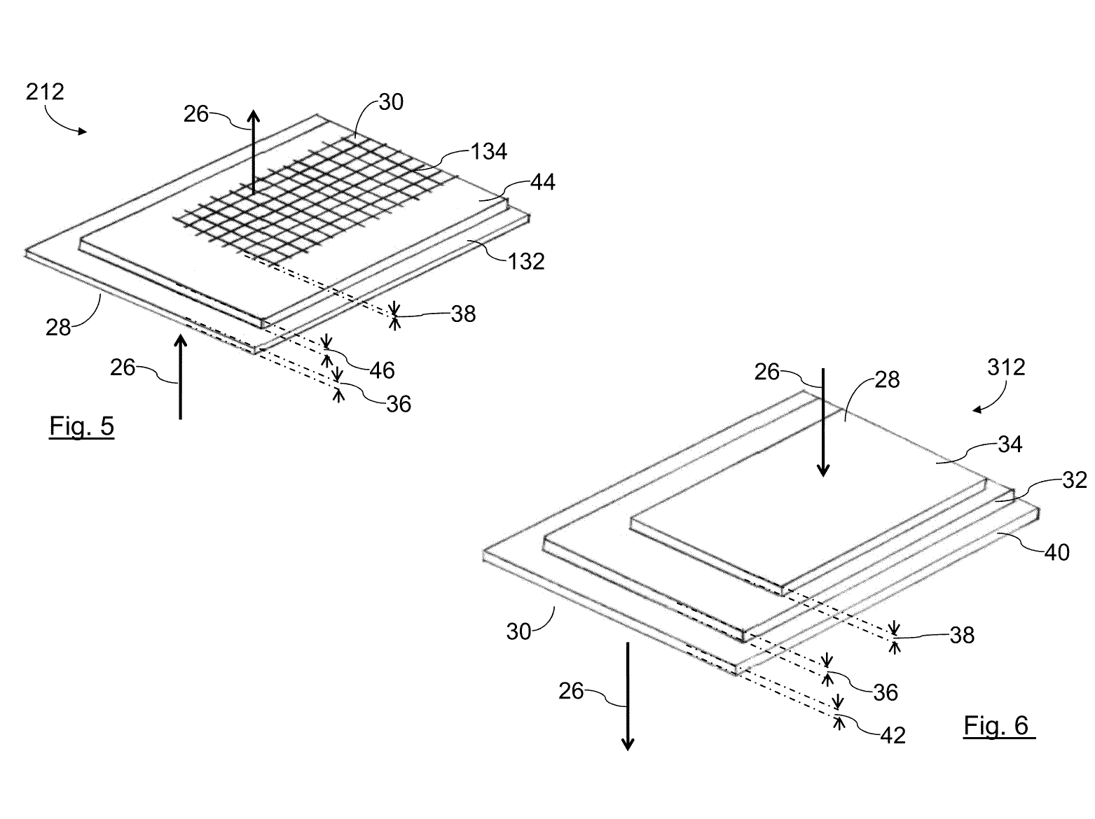

FIG. 5 shows a filter medium 212 according to a third exemplary embodiment, which can be used for the filter element 10. In contrast to the second exemplary embodiment from FIG. 4, an ultrafine filter layer 44 is provided instead of the barrier layer 40.

The ultra-fine filter layer 44 is produced using a meltblown method. The ultra-fine filter layer 44 can be designated as meltblown layer. A pore size of the ultra-fine filter layer 44 is smaller than the pore size of the nonwoven filtration layer 132. The ultra-fine filter layer 44 acts as a fine filter that is able to filter out smaller particles than with the nonwoven filtration layer 132. The ultra-fine filter layer 44 has a thickness 46 between 100 μm and 500 μm. The ultra-fine filter layer 44 has a mass per unit area between 15 g/m² and 100 g/m². Air permeability of the ultra-fine filter layer 44 is in a range between 40 l/m²s and 100 l/m²s. Fiber diameters of the ultra-fine layer 44 range between 0.1 μm and 15 μm. The ultra-fine filter layer 44 is made from the same material as the mesh support layer 134 and the nonwoven filtration layer 132 of the filter medium 212. It can be made from polyamide, polypropylene or a copolymer.

In the FIGS. 6 to 8, a fourth, fifth and a sixth exemplary embodiment of a filter medium 312, 412 and 512 are shown, which can be used for the filter element 10 from the FIGS. 1 and 2, wherein the flow direction of the urea solution is reversed by the filter element 10. In this case, instead of flowing radially from the inside to the outside, the urea solution flows radially from the outside to the inside.

In the fourth exemplary embodiment according to FIG. 6, the spunbond support layer 34 is located on the inflow side 28 of the filter medium 312. The spunbond support layer 34 features the properties listed above in connection with the first exemplary embodiment according to FIG. 3. In the case that the urea solution cools below the freezing point and, for example, ice particles can be formed, the spunbond support layer 34 on the inflow side 28 of the filter medium 312 serves as protection against ice blast.

The barrier layer 40 is located on the outflow side 30 of the filter medium 312. The barrier layer 40 features the properties and analogous functions as listed above in connection with the second exemplary embodiment according to FIG. 4.

Between the barrier layer 40 and the spunbond support layer 34, the meltblown filtration layer 32 is arranged. The meltblown filtration layer 32 features the properties and analogous functions as listed above in connection with the first exemplary embodiment according to FIG. 3.

The spunbond support layer 34, the barrier layer 40 and the meltblown filtration layer 32 of the filter medium 312 are made from the same material. They are made from polyamide or polypropylene or a copolymer.

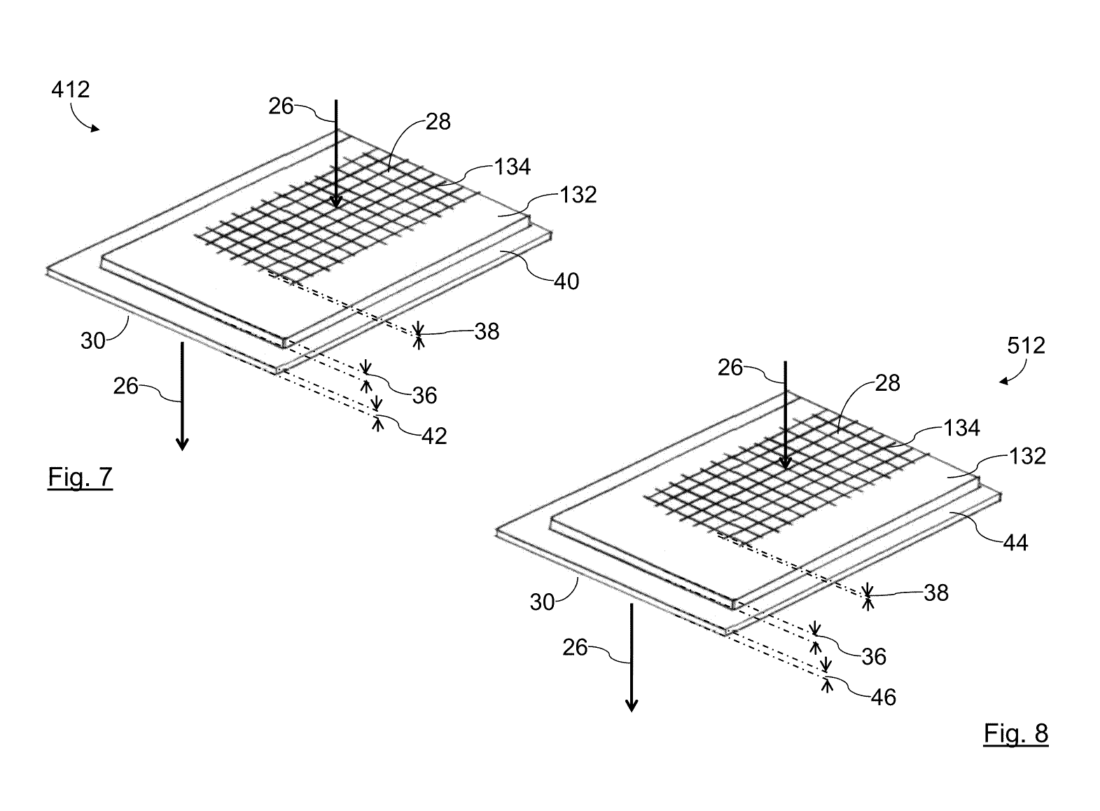

In the fifth exemplary embodiment shown in FIG. 7, the mesh support layer 134 is arranged on the inflow side 28 of the filter medium 412. The mesh support layer 134 features the properties and analogous functions as listed above in connection with the second exemplary embodiment according to FIG. 4.

The nonwoven filtration layer 132 is located between the mesh support layer 134 and the barrier layer 40. The nonwoven filtration layer 132 features the properties and analogous functions as listed above in connection with the second exemplary embodiment according to FIG. 4.

The barrier layer 40 is located on the outflow side 30 of the filter medium 412. The barrier layer 40 features the properties and analogous functions as listed above in connection with the second exemplary embodiment according to FIG. 4.

The mesh support layer 134, the barrier layer 40 and the nonwoven filtration layer 132 of the filter medium 412 are made from the same material. They are made of polyamide or polypropylene or a copolymer.

In contrast to the fifth exemplary embodiment from FIG. 7, in the sixth exemplary embodiment of a filter medium 512 shown in FIG. 8, instead of the barrier layer 40, the ultra-fine filter layer 44 is arranged on the outflow side 30 of the filter medium 512. The ultra-fine filter layer 44 features the properties and analogous functions as listed above in connection with the third exemplary embodiment according to FIG. 5.

The mesh support layer 134, the ultra-fine filter layer 44 and the nonwoven filtration layer 132 of the filter medium 412 are made from the same material. They are made of polyamide or polypropylene or a copolymer.

For the filter medium 112, 212, 412 and 512 according to the second, third, fifth and sixth exemplary embodiment from the FIGS. 4, 5, 7 and 8 it is also possible to use a support layer from a fabric (fabric support layer) instead of the mesh support layer 134. A yarn diameter of the fabric support layer ranges between 100 μm and 500 μm, preferably between 300 μm and 450 μm. The fabric support layer has a thickness of between 300 μm and 900 μm, preferably between 500 μm and 800 μm. A mass per unit area of the fabric support layer is in a range between 100 g/m² and 300 g/m², preferably between 200 g/m² and 280 g/m². The fabric support layer is made from the same material as the other layers of the corresponding filter medium 112, 212, 412 and 512.

What is claimed is:

1. A filter element of a filter for filtering fluid, the filter element comprising:
a multilayer filter medium through which the fluid flows for filtration in a flow direction from an inflow side to an outflow side of the filter medium;
wherein the filter medium comprises several layers including at least one filtration layer and at least one support layer;
wherein the at least one support layer is adapted to support the filter medium against pressures having pressure gradients transverse or oblique to the flow direction of the fluid through the filter medium.

2. The filter element according to claim 1, wherein the at least one support layer comprises a fabric layer.

3. The filter element according to claim 1, wherein the at least one support layer comprises a mesh layer.

4. The filter element according to claim 1, wherein the at least one support layer comprises a spunbond layer.

5. The filter element according to claim 1, wherein the at least one filtration layer is arranged downstream of the at least one support layer in the flow direction of the fluid through the filter medium.

6. The filter element according to claim 1, wherein the at least one support layer is arranged at the inflow side of the filter medium.

7. The filter element according to claim 1, wherein the at least one filtration layer is arranged upstream of the at least one support layer in the flow direction of the fluid through the filter medium.

8. The filter element according to claim 1, wherein the at least one support layer is arranged at the outflow side of the filter medium.

9. The filter element according to claim 1, wherein the at least one filtration layer comprises a nonwoven layer.

10. The filter element according to claim 1, wherein the at least one filtration layer is at least partially melt-blown.

11. The filter element according to claim 1, wherein the filter medium further comprises at least one barrier layer.

12. The filter element according to claim 11, wherein the at least one barrier layer comprises a spunbond layer.

13. The filter element according to claim 1, wherein the filter medium comprises at least one ultra-fine filter layer.

14. The filter element according to claim 13, wherein the at least one ultra-fine filter layer is at least partially melt-blown.

15. The filter element according to claim 1, wherein at least one of the several layers of the filter medium contains polyamide; polypropylene; or polyamide and polypropylene.

16. The filter element according to claim 1, wherein the filter element is a hollow filter element.

17. A multilayer filter medium of a filter for filtering fluid that flows through the filter medium for filtration, the filter medium comprising:
at least one filtration layer;
at least one support layer;
wherein the at least one support layer is adapted to support the filter medium against pressures having pressure gradients transverse or oblique to the flow direction of the fluid through the filter medium.

18. A filter for filtering fluid, the filter comprising:
a multilayer filter medium through which the fluid flows flow for filtration in a flow direction from an inflow side to an outflow side of the filter medium;
wherein the filter medium comprises several layers including at least one filtration layer and at least one support layer;
wherein the at least one support layer is adapted to support the filter medium against pressures having pressure gradients transverse or oblique to the flow direction of the fluid through the filter medium.
